(19) United States
(12) Patent Application Publication
(10) Pub. No.: US 2007/0263545 A1
(43) Pub. Date: Nov. 15, 2007

(54) Network diagnostic systems and methods for using network configuration data

(76) Inventors: Craig E. Foster, Santa Cruz, CA (US); David D. Perry, Santa Cruz, CA (US); Genti Cuni, Mountain View, CA (US); Adam H. Schondelmayer, Cupertino, CA (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/433,290

(22) Filed: May 12, 2006

(51) Int. Cl. G06F 11/00

(52) U.S. Cl. 370/241; 714/4

(57) ABSTRACT

A network diagnostic module may use network configuration data in performing network diagnostic methods. The network diagnostic module may use network configuration data to generate baseline network activity data. The network diagnostic module may use network configuration data to identify network components and aggregate network activity data for the components. The network diagnostic module may use network configuration data to identify sets of network components and to access network activity data for the sets. The network diagnostic module may use network activity data to identify sets of network components and to access network configuration data for the sets.

### BACKGROUND OF THE INVENTION

1. Field of the Invention

The present invention generally relates to network diagnostic systems and in particular to network diagnostic systems that may use network configuration data.

2. Background Technology

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANS”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of (installed networks.

As the demand for networks has grown, network technology has developed to the point that many different physical configurations presently exist. Examples include Gigabit Ethernet (“GE”), 10 GE, Fiber Distributed Data Interface (“FDDI”), Fibre Channel (“FC”), Synchronous Optical Network (“SONET”) and InfiniBand networks. These networks, and others, typically conform to one of a variety of established standards, or protocols, which set forth rules that govern network access as well as communications between and among the network resources. Typically, such networks utilize different cabling systems, have different characteristic bandwidths and typically transmit data at different speeds. Network bandwidth, in particular, has been the driving consideration behind many advancements in the area of high speed communication systems, methods and devices.

For example, the ever-increasing demand for network bandwidth has resulted in the development of technology that increases the amount of data that can be pushed through a single channel on a network. Advancements in modulation techniques, coding algorithms and error correction have vastly increased the rates at which data can be transmitted across networks. For example, in years past, the highest rate that data could travel across a network was at about one Gigabit per second. This rate has increased to the point where data can travel across Ethernet and SONET networks at rates as high as 10 gigabits per second, or faster.

As communication networks have increased in size, speed and complexity however, they have become increasingly likely to develop a variety of problems that, in practice, have proven difficult to diagnose and resolve. Such problems are of particular concern in light of the continuing demand for high levels of network operational reliability and for increased network capacity.

The problems generally experienced in network communications can take a variety of forms and may occur as a result of a variety of different circumstances. Examples of circumstances, conditions and events that may give rise to network communication problems include the transmission of unnecessarily small frames of information, inefficient or incorrect routing of information, improper network configuration and superfluous network traffic, to name just a few. Such problems are aggravated by the fact that networks are continually changing and evolving due to growth, reconfiguration and introduction of new network topologies and protocols. Moreover, new network interconnection devices and software applications are constantly being introduced and implemented. Circumstances such as these highlight the need for effective, reliable, and flexible diagnostic mechanisms.

### BRIEF SUMMARY OF EMBODIMENTS OF THE INVENTION

A need therefore exists for network diagnostic systems and methods that eliminate or reduce the disadvantages and problems listed above and/or other disadvantages and problems.

One aspect is a network diagnostic method that may comprise using network configuration data to automatically generate component-specific baseline network activity data from first network activity data. The network diagnostic method may also comprise accessing second network activity data and comparing the component-specific baseline network activity data and the second network activity data. The network diagnostic method may further comprise providing an alarm at least partially in response to comparing the component-specific baseline network activity data and the second network activity data. A further aspect is a diagnostic module that may perform the network diagnostic method.

Another aspect is a network diagnostic method that may comprise using network configuration data to identify a plurality of network components; and aggregating network activity data for the plurality of network components. A further aspect is a diagnostic module that may perform the network diagnostic method.

Yet another aspect is a network diagnostic method that may comprise using network configuration data to identify a first set of one or more network components and a second set of one or more network components; accessing first network activity data for the first set of one or more network components; accessing second network activity data for the second set of one or more network components; and comparing the first network activity data and the second network activity data. A further aspect is a diagnostic module that may perform the network diagnostic method.

Yet another aspect is a network diagnostic method that may comprise using network activity data to identify a first set of one or more network components and a second set of one or more network components; accessing first network configuration data for the first set of one or more network components; accessing second network configuration data for the second set of one or more network components; and comparing the first network configuration data and the second network configuration data. A further aspect is a diagnostic module that may perform the network diagnostic method.

Still another aspect is a network diagnostic method that may comprise automatically generating component-specific baseline network activity data from first network activity data.

For purposes of summarizing, some aspects, advantages, and novel features have been described. Of course, it is to be understood that not necessarily all such aspects, advantages, or features will be embodied in any particular embodiment of the invention. Further, embodiments of the invention may comprise aspects, advantages, or features other than those that have been described. Some aspects, advantages, or features of embodiments of the invention may become more fully apparent from the following description and appended claims or may be learned by the practice of embodiments of the invention as set forth in this disclosure.

### BRIEF DESCRIPTION OF THE DRAWINGS

The appended drawings contain figures of preferred embodiments to further clarify the above and other aspects, advantages and features of the present invention. It will be appreciated that these drawings depict only preferred embodiments of the invention and are not intended to limits its scope. The invention will be described and explained with additional specificity and detail through the use of the accompanying drawings in which:

FIG. 1 is a block diagram of an exemplary networking system;

FIG. 2 is a flowchart of an exemplary network diagnostic method;

FIG. 3 is a flowchart illustrating an exemplary embodiment of a portion of the method shown in FIG. 2;

FIG. 4 is a flowchart illustrating an exemplary embodiment of a portion of the method shown in FIG. 2;

FIG. 5 is a flowchart of another exemplary network diagnostic method;

FIG. 6 is a flowchart of yet another exemplary network diagnostic method; and

FIG. 7 is a flowchart of still another exemplary network diagnostic method.

### DETAILED DESCRIPTION OF THE PREFERRED EMBODIMENTS

Certain embodiments relate generally to networking systems, including the testing of high speed data transmission systems and components. Embodiments of the invention may be used in other contexts unrelated to testing systems and components and/or unrelated to high speed data transmission.

### Exemplary Networking System

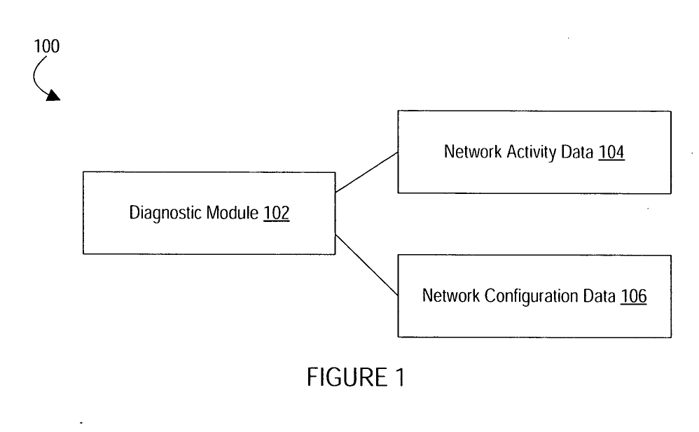

FIG. 1 is a block diagram of an exemplary networking system 100. The networking system 100 may comprise a network, network diagnostic system, a network testing system, or the like including one or more diagnostic modules (such as, the diagnostic module 102). In one embodiment, the diagnostic module 102 may comprise one or more hardware modules, one or more software modules, or both.

The networking system 100 may also include one or more nodes (not shown). As used herein, a “node” includes, but is not limited to, a server; host; a client; storage device; a switch; a hub; a router; all or a portion of a SAN fabric; a diagnostic device; and any device that may be coupled to a network and that may receive and/or monitor a signal or data over at least a portion of a network, that may send and/or generate a signal or data over at least a portion of a network, or both. In one embodiment, a signal (such as, an electrical signal, an optical signal, and the like) may be used to send and/or receive network messages over at least a portion of a network. As used herein, a “network message” includes, but is not limited to, a packet; a datagram; a frame; a data frame; a command frame; an ordered set; any unit of data capable of being routed (or otherwise transmitted) through a computer network; and the like. In one embodiment, a network message may comprise transmission characters used for data purposes, protocol management purposes, code violation errors, and the like. Also, an ordered set may include, a Start of Frame (“SOF”), an End of Frame (“EOF”), an Idle, a Receiver_Ready (“R_RDY”), a Loop Initialization Primitive (“LIP”), an Arbitrate (“ARB”), an Open (“OPN”), and Close (“CLS”)—such as, those used in certain embodiments of Fibre Channel. Of course, any ordered sets and/or any network messages of any other size, type, and/or configuration may be used, including, but not limited to, those from any other suitable protocols. Nodes may communicate using suitable network protocols, including, but not limited to, serial protocols, physical layer protocols, channel protocols, packet-switching protocols, circuit-switching protocols, Ethernet, Fast Ethernet, Gigabit Ethernet, 10 Gigabit Ethernet, Fibre Channel, Fibre Channel Arbitrated Loop (“FC-AL”), Small Computer System Interface (“SCSI”), High Performance Parallel Interface (“HIPPI”), Serial Attached SCSI (“SAS”), Serial ATA (“SATA”), SAS/SATA, Serial SCSI Architecture (“SSA”), and the like.

The diagnostic module 102 may perform one or more network diagnostic methods. In performing the network diagnostic methods, the diagnostic module 102 may generate network activity data 104; access network activity data 104; access network configuration data 106; perform other processes; or any combination thereof.

### Exemplary Network Activity Data

As mentioned above, the diagnostic module 102 may access network activity data 104. The network activity data 104 may be generated by a protocol analyzer, a monitor, and any other appropriate device. In one embodiment, the diagnostic module 102 may be configured to function as the protocol analyzer, monitor, or other device to generate the network activity data 104 that the diagnostic module 102 accesses.

Protocol Analyzer

In some embodiments, a protocol analyzer (or network analyzer) may be used to analyze a bit sequence and generate network activity data 104 from that analysis. The bit sequence typically comprises one or more network messages (such as, packets, frames, or other protocol-adapted network messages); and the network activity 104 generated by the protocol analyzer may include various statistics, for example, one or more counts of various data transmission faults, one or more counts of various transmissions errors, one or more counts of various performance errors (known generally as problem conditions), one or more counts of network messages having particular characteristics, and the like.

To generate the network activity data 104, the protocol analyzer may be configured to compare the bit sequence (or at least a portion thereof) with one or more bit sequences or patterns. Before performing this comparison, the protocol analyzer may optionally apply one or more bit masks to the received bit sequence. In performing this comparison, the protocol analyzer may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence that comprises a network message having particular characteristics—such as, for example, having an unusual network address, having a code violation or character error, having an unusual timestamp, having an incorrect CRC value, indicating a link re-initialization, and/or having a variety of other characteristics.

To generate the network activity data 104, the protocol analyzer may detect a network message having any specified characteristics, which specified characteristics may be user-selected via user input. It will be appreciated that a specified characteristic could be the presence of an attribute or the lack of an attribute. Also, it will be appreciated that the network analyzer may detect a network message having particular characteristics using any other suitable method.

To generate the network activity data 104, the protocol analyzer may optionally be configured to filter network messages (for example, network messages having or lacking particular characteristics), such as, messages from a particular node, messages to a particular node, messages between or among a plurality of particular nodes, network messages of a particular format or type, messages having a particular type of error, and the like. Accordingly, using one or more bit masks, bit patterns, and the like, the protocol analyzer may be used identify network messages having particular characteristics and determine whether to analyze or to discard those network messages based at least in part upon those particular characteristics.

Monitor

In some embodiments, a monitor may be used to generate network activity data 104 comprising statistics derived from one or more network messages having particular characteristics, one or more conversations having particular characteristics, and the like.

To determine the network messages and/or the conversations from which statistics should be derived, the monitor may be configured to compare a bit sequence—such as one or more network messages—with one or more bit sequences or patterns. Before performing this comparison, the monitor may optionally apply one or more bit masks to the bit sequence. In performing this comparison, the monitor may determine whether all or a portion of the bit sequence (or the bit-masked version of the bit sequence) matches and/or does not match the one or more bit patterns. In one embodiment, the bit patterns and/or the bit masks may be configured such that the bit patterns will (or will not) match with a bit sequence (or portion thereof) when the bit sequence comprises a network message from a particular node, a network message to a particular node, a network message between or among a plurality of particular nodes, a network message of a particular format or type, a network message having a particular error, and the like. Accordingly, the monitor may be configured to detect a network message having any specified characteristics—including but not limited to whether the network message is associated with a particular conversation among nodes.

Upon detecting a network message having specified characteristics, the monitor may create and update table entries to maintain statistics for individual network messages and/or for conversations between nodes. For example, a monitor may count the number of physical errors (such as, bit transmission errors, CRC error, and the like), protocol errors (such as, timeouts, missing network messages, retries, out of orders), other error conditions, protocol events (such as, an abort, a buffer-is-full message), and the like. Also, as an example, the monitor may create conversation-specific statistics, such as, the number of packets exchanged in a conversation, the response times associated with the packets exchanged in a conversation, transaction latency, block transfer size, transfer completion status, aggregate throughput, and the like. It will be appreciated that a specified characteristic could be the presence of an attribute or the lack of an attribute.

In some embodiments, the diagnostic module 102 may include any features and/or perform any method described in U.S. patent application Ser. No. 10/769,202, entitled MULTI-PURPOSE NETWORK DIAGNOSTIC MODULES and filed on Jan. 30, 2004, which is hereby incorporated by reference herein in its entirety.

Network activity data may include network activity statistics for various events, types of network messages and the like including, but not limited to, frames/sec [Total number of frames of any type per second]; MB/sec [Total megabytes of frame payload data per second, which preferably does not include the SOF, Header, CRC or EOF]; SCSI MB/sec [Total megabytes of SCSI frame payload data per second. This preferably includes all SCSI Command, Transfer Ready, Data and Status frames]; SCSI Frames/sec [Total number of SCSI frames per second. This preferably includes all SCSI Command, Transfer Ready, Data and Status frames.]; Application Data MB/sec [Total megabytes of Application payload data per second. Application Data preferably refers only to the payload of Solicited and Unsolicited Data frames]; Application Data Frames/sec [Total Application data frames per second. Application Data preferably refers only to the payload of Solicited and Unsolicited Data frames.]; Management MB/sec [Total megabytes of FC Management frame payload data per second. This preferably does not include the SOF, Header, CRC or EOF. This is preferably a count of all Extended Link Services (ELS), Basic Link Services (BLS), Fibre Channel Services (FCS), Link Control (LC) and Fabric Frames (SOF(f))]; Management Frames/sec [Total number of Fibre Channel Management Frames per second. This is preferably a count of all Extended Link Services (ELS), Basic Link Services (BLS), Fibre Channel Services (FCS), Link Control (LC) and Fabric Frames (SOF(f)).]; Other MB/sec [Total mega bytes of Non-Management and Non-SCSI frame payload data per second. Preferably does not include the SOF, Header, CRC or EOF.]; Other Frames/sec [Total number of Non-Management and Non-SCSI frames per second]; Total Capacity % [Amount of overall Bus Capacity utilized in FRAME activity per second. This preferably includes Management, SCSI, and Other capacity.]; Management Capacity % [Amount of overall Bus Capacity utilized in Fibre Channel Management FRAME activity per second.]; SCSI Capacity % [Amount of overall Bus Capacity utilized in SCSI FRAME activity per second.]; Other Capacity % [Amount of overall Bus Capacity utilized in Fibre Channel Management FRAME activity per second.]; Count of Loss of Signal Events; Count of Loss of Sync Events; Count of NOS/OLS Events; Count of LIP Events; Count of Fibre Channel Link Up Events; Count of LIP or NOS/OLS events; Count of Code Violations; Count of Extended Link Services Frames; Count of Fibre Channel Services Frames; Count of Fabric SOFf Frames; Count of Basic Fibre Channel Link Services; Count of Fibre Channel Link Control Frames; Count of Logins Frames; Count of Logout Frames; Count of Abort Sequence Frames; Count of Notifications [Number of Registered State Change Notification (RSCN) frames plus Fabric Address Notification (FAN) frames]; Count of Reject Frames; Count of Busy Frames; Count of Accept Frames; Count of Loop Initialization Frames; Count of Check Condition Status of Frames; and Count of Other Bad Status Frames; Count of Task Management Frames/sec; Capacity % [Amount of overall Bus Capacity utilized in FRAME activity per second.]; minimum number of pending exchanges in an interval; maximum number of pending exchanges in an interval; number of currently pending exchanges; Read/Write/Other Data Frame/sec; Read/Write/Other Data MB/sec; Read/Write/Other Commands Issued [Total number of SCSI Read/Write/Other Command frames issued in an interval.]; Total Read/Write/Other Exchange Completion Time (ms) [Total time for all the SCSI Read/Write/Other Exchange Commands that completed in an interval.]; Min Read/Write/Other Size [Minimum number of data bytes requested for any SCSI Read/Write/Other Exchange that completed in an interval.]; Max Read/Write/Other Size [Maximum number of data bytes requested for any SCSI Read/Write/Other Exchange that completed in an interval.]; Min Read/Write/Other Exchange Completion Time (ms) [Minimum amount of elapsed time (in milliseconds) for any SCSI Read/Write/Other Exchange that completed in an interval.]; Max Read/Write/Other Exchange Completion Time (ms) [Maximum amount of elapsed time (in milliseconds) for any SCSI Read/Write/Other Exchange that completed in an interval.]; Count of Received bytes; Count of Transmitted bytes; Count of Received frames; Count of Transmitted frames; Count of CRC Errors; Count of Link Resets Received; Count of Link Resets Transmitted; Count of Link Failures; Count of Loss of Signal; Count of Loss of Sync; Count of Class3Discards; and other suitable network activity data disclosed in NetWisdom 2.1 User's Guide (copyright 2005), which is hereby incorporated by reference herein and which available from Finisar Corporation having offices 1389 Moffett Park Drive, Sunnyvale, Calif. 94089-1133, USA.

### Exemplary Network Configuration Data

As mentioned above, the diagnostic module 102 may access network configuration data 106. The network configuration data 106 preferably includes configuration data for storage devices, servers, switches and/or other nodes or components of the networking system 100.

The network configuration data 106 related to storage devices may include, but is not limited to, LUN maps, the manufacturer of a storage device, the number of ports on a storage device, the speed of a storage device's ports, the settings of a storage device's ports (such as, operating system type, patch level of operating system), which of a storage device's ports are on which controllers, the number of controllers on a storage device, which volumes are on a storage device, which disk drives are on a volume, the RAID level of a volume, the storage space on a storage device (used and/or available), the number of paths to a volume, and a storage device's software versions or levels.

The network configuration data 106 related to servers may include, but is not limited to, the identity of host bus adapters in a server, the number of ports on a host bus adapter in a server, the identity of the world wide names of the ports on a host bus adapter in a server, the speed of the ports on a host bus adapter in a server, the configuration of the ports on a host bus adapter in a server, the driver versions for the software of a host bus adapter in a server, the settings of the ports on a host bus adapter in a server (such as, operating system type, patch level of operating system), the identity of the LUNs visible to a host bus adapter in a server, the configuration of the server, and the CPU utilization of the server.

The network configuration data 106 related to switches may include, but is not limited to, the manufacturer of a switch, the model of a switch, the software version run by a switch, the number of ports on a switch, the speed of the ports on a switch, which of the ports on a switch are active, which port is connected to which port on a switch, which nodes are connected to which ports on a switch, the topology formed by a switch, and security management information (such as what initiators can communicate to what targets).

It will be appreciated that the network configuration data 106 may include other network configuration data related to storage devices, switches and/or servers. It will also be appreciated that the network configuration data need not be related to storage devices, switches or servers and may be related to other nodes or components of a networking system.

### Exemplary Baseline-Related Method

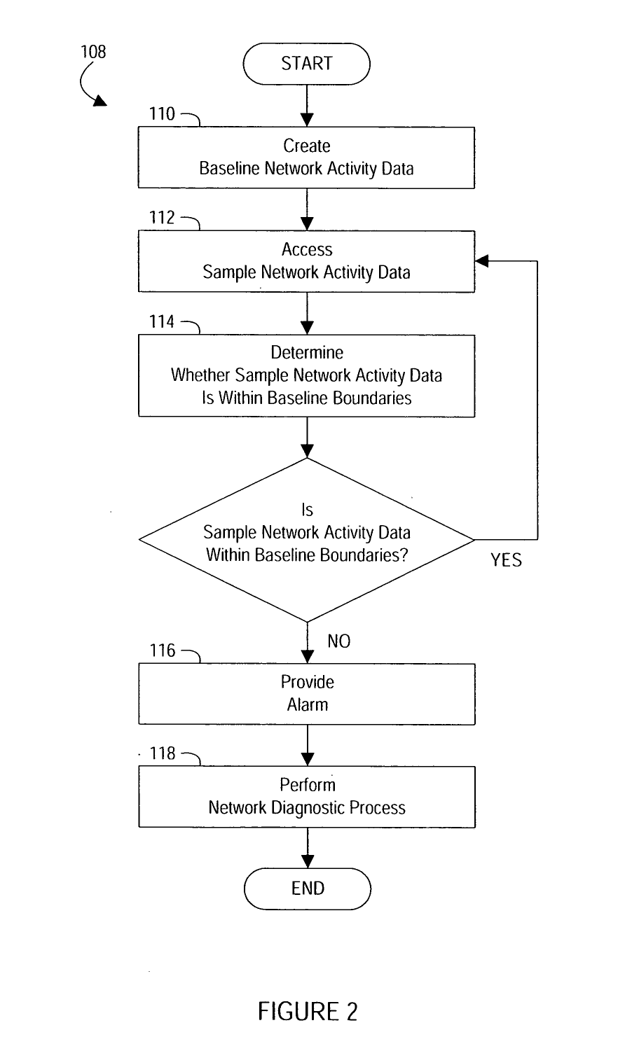

As shown in FIG. 2, the diagnostic module 102 preferably may perform some or all of a network diagnostic method 108; however, some or all of the method 108 may be performed by the diagnostic module 102; one or more other suitable modules, systems, and the like; or any suitable combination of one or more thereof. Of course, the entire method 108 need not be performed; and any part or parts of the method 108 may be performed to provide a useful method 108.

At a block 110, the diagnostic module 102 may create baseline network activity data. The baseline network activity data may comprise one or more boundaries, which may compared to network activity data. For example, the boundaries may be compared to network activity data generated from subsequent network activity, which may be used determining whether provide an alarm, perform a network diagnostic process, and/or perform other processes.

In further detail, at a block 112, the diagnostic module 102 may access sample network activity data comprising network activity data generated from a sample of network activity within the networking system 100. The sample network activity data may be generated by the diagnostic module 102; one or more other suitable modules, systems, and the like; or any suitable combination of one or more thereof.

At a block 114, the diagnostic module 102 may determine whether the sample network activity data is within the boundaries of the baseline network activity data by, for example, comparing the sample network activity data and the boundaries.

The baseline boundaries may advantageously be configured to define acceptable and/or unacceptable network activity. For example, network activity data that is not within the baseline boundaries may represent unacceptable network activity. Accordingly, if the sample network activity data is not within the baseline boundaries at the block 114, the diagnostic module 102 may provide an alarm (at a block 116) and/or perform one or more network diagnostic functions (at a block 118). However, if the sample network activity data is within the baseline boundaries at the block 114, the diagnostic module 102 may return to the block 112 to access further sample network activity data and, at the block 114, determine whether the further sample network activity data is within the baseline boundaries.

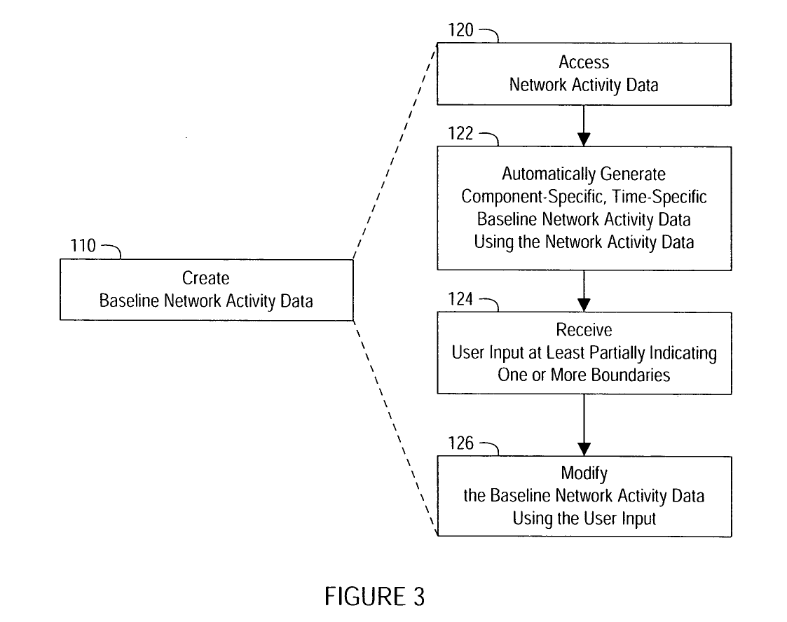

As shown in FIG. 3, the block 110 (FIG. 2) may include one or more blocks to create the baseline network activity data, such as blocks 120, 122, 124, 126.

At the block 120, the diagnostic module 102 may access network activity data generated from network activity within the networking system 100. The network activity data may be generated by the diagnostic module 102; one or more other suitable modules, systems, and the like; or any suitable combination of one or more thereof.

At a block 122, the diagnostic module 102 may automatically generate component-specific and/or time-specific baseline network activity data from the network activity data accessed at the block 120. For example, the diagnostic module 102 may use the network activity data accessed at the block 120 and the network configuration data 106 (FIG. 1) to automatically generate baseline network activity data that comprises at least one normal or expected network activity statistic for a particular component of the networking system 100. Also, for example, the diagnostic module 102 may use the network activity data accessed at the block 120 and a component identifier (such as, an address, an IP address, or any other suitable identifier of a particular component of the networking system 100) to automatically generate baseline network activity data that comprises at least one normal or expected network activity statistic for that component. The normal or expected activity statistic may be generated for a set of one or more days of the week, a specific time range in a set of one or more days, or the like. In one embodiment, the diagnostic module 102 may be configured to repeatedly update the normal or expected network activity statistic as additional network activity data is generated at the block 120. It will be appreciated that the diagnostic module 102 does not require any network configuration data 106 in order for the diagnostic module 102 to automatically generate component-specific and/or time-specific baseline network activity data.

At the block 124, the diagnostic module 102 may receive user input at least partially indicating one or more boundaries. For example, after automatically accessing at least one normal or expected activity statistic at the block 122, a user may review that statistic and may input baseline boundaries for that statistic. Also, for example, a user may input a tolerance value. The tolerance value may be used with a normal or expected network activity statistic to calculate baseline boundaries for that statistic. The tolerance value may comprise a percentage, a standard deviation, a fixed value or other suitable values that may be used to derive baseline boundaries from a normal or expected activity statistic.

At the block 126, the diagnostic module 102 may modify the baseline network activity data using the user input received at the block 124. For example, the baseline network activity data may comprise at least one normal or expected network activity statistic, and the user input may comprise a tolerance value. The diagnostic module 102 may derive baseline boundaries from the statistic and user input, and the diagnostic module may save those baseline boundaries as at least part of the baseline network activity data. Also, for example, the user input may comprise baseline boundaries, which the diagnostic module 102 may save as at least part of the baseline network activity data.

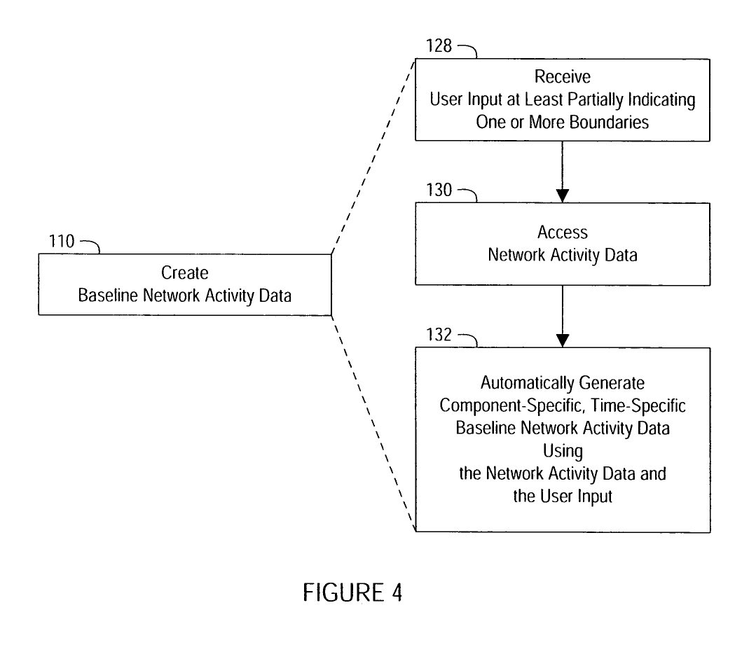

As shown in FIG. 4, the block 110 (FIG. 2) may include one or more blocks to create the baseline network activity data, such as blocks 128, 130, 132. At the block 128, the diagnostic module 102 may receive user input at least partially indicating one or more boundaries, such as a tolerance value.

At the block 130, the diagnostic module 102 may access network activity data generated from network activity within the networking system 100. The network activity data may be generated by the diagnostic module 102; one or more other suitable modules, systems, and the like; or any suitable combination of one or more thereof.

At a block 132, the diagnostic module 102 may automatically generate component-specific and/or time-specific baseline network activity data from the network activity data accessed at the block 130 and, if desired, also from the user input received at the block 128. For example, the diagnostic module 102 may use the network activity data accessed at the block 130 and the network configuration data 106 (FIG. 1) to automatically generate baseline network activity data that comprises at least one normal or expected network activity statistic for a particular component of the networking system 100. The normal or expected activity statistic may be generated for a set of one or more days of the week, a specific time range in a set of one or more days, or the like. In addition, the user input received at the block 128 may comprise a tolerance value. Accordingly, at the block 132, the diagnostic module 102 may derive baseline boundaries from the user input and the normal or expected activity statistic; and the diagnostic module may save those baseline boundaries as at least part of the baseline network activity data.

It will be appreciated that the block 110 (FIG. 2) does not require the blocks 120, 122, 124, 126 (FIG. 3) or the blocks 128, 130, 132 (FIG. 4) and, thus, the block 110 may be implemented in any other suitable fashion.

### Exemplary Aggregation-Related Method

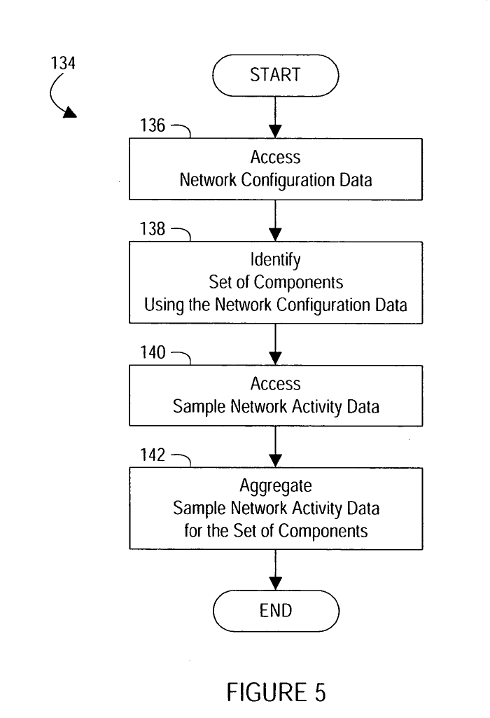

As shown in FIG. 5, the diagnostic module 102 preferably may perform some or all of a network diagnostic method 134; however, some or all of the method 134 may be performed by the diagnostic module 102; one or more other suitable modules, systems, and the like; or any suitable combination of one or more thereof. Of course, the entire method 134 need not be performed; and any part or parts of the method 134 may be performed to provide a useful method 134.

At a block 136, the diagnostic module 102 may access the network configuration data 106 (FIG. 1).

At a block 138, the diagnostic module 102 may use that network configuration data 106 to identify a set of components of the networking system 100. For example, the diagnostic module 102 may use the network configuration data 106 to identify a plurality of communication links through which a particular node (such as a storage device) sends and receives network messages.

At a block 140, the diagnostic module 102 may access sample network activity data comprising network activity data generated from a sample of network activity. In one embodiment, the network activity may be sampled for the set of components identified at the block 138. For example, first network activity may be sampled for a first link using a first network analyzer or monitor configured to receive network messages from the first link, and second network activity may be sampled for a second link using a second network analyzer or monitor configured to receive network messages from the second link.

At the block 142, the diagnostic module 102 may aggregate the sample network activity data accessed at the block 140 for the set of components identified at the block 138. Accordingly, where a first network analyzer or monitor is coupled to the first link and where a second network analyzer or monitor is coupled to the second link, the diagnostic module 102 may aggregate portions of the sample network activity data associated with those links to create aggregated network activity data for a node that sends and receives messages through those links. For example, the diagnostic module 102 may average statistics calculated for the links, may sum statistics calculated for the links, and/or may perform other suitable operations to aggregate those statistics.

### Exemplary Comparison-Related Methods

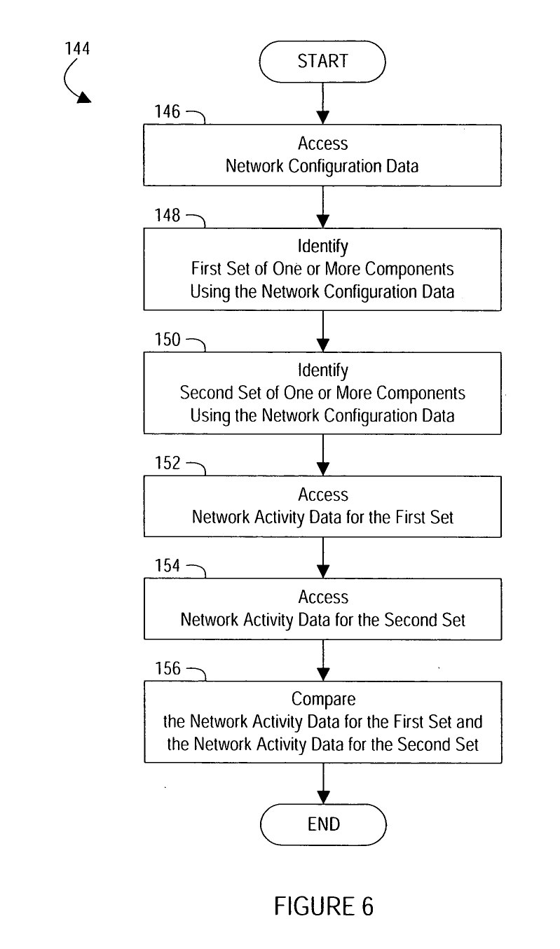

As shown in FIG. 6, the diagnostic module 102 preferably may perform some or all of a network diagnostic method 144; however, some or all of the method 144 may be performed by the diagnostic module 102; one or more other suitable modules, systems, and the like; or any suitable combination of one or more thereof. Of course, the entire method 144 need not be performed; and any part or parts of the method 144 may be performed to provide a useful method 144.

At a block 146, the diagnostic module 102 may access the network configuration data 106 (FIG. 1).

The diagnostic module 102 may use the network configuration data 106 to identify a first set of one or more components of the networking system 100 at the block 148 and to identify a second set of one or more components of the networking system 100 at the block 150. In one embodiment, the diagnostic module 102 may identify the members of the first set and/or the second set based upon one or more shared network configuration characteristics. The diagnostic module 102 may identify the members of the first and second sets based upon their manufacturer, their type of node, and/or other suitable network configuration data. For example, the first set could comprise storage devices from one manufacturer, and the second set could comprise storage devices from one or more different manufacturers. It will be appreciated that the diagnostic module 102 may identify the members of the first set and/or the second set based upon any other suitable network configuration data.

The diagnostic module 102 may access network activity data for the first set of components at the block 152 and may access network activity data for the second set of components at the block 154. At the block 156, the diagnostic module 102 may compare the network activity data for the first set with the network activity data for the second set. Advantageously, this comparison may be used to identify one or more particular network configuration characteristics may affect the network activity of first and second sets of components. For example, this comparison could be used to determine that storage devices of one manufacturer are running slower than storage devices of other manufacturers. Also, for example, this comparison could be used to determine that switches running one version of a software product (such as a driver) experience more errors than switches running other versions of the software product. Of course, this comparison may be used to identify any other network configuration characteristics may affect the network activity of first and second sets of components.

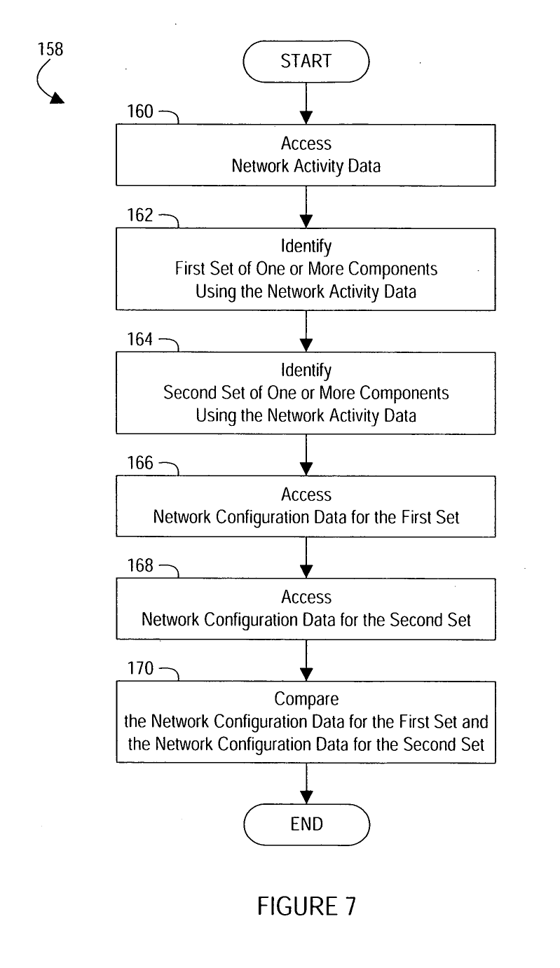

As shown in FIG. 7, the diagnostic module 102 preferably may perform some or all of a network diagnostic method 158; however, some or all of the method 158 may be performed by the diagnostic module 102; one or more other suitable modules, systems, and the like; or any suitable combination of one or more thereof. Of course, the entire method 158 need not be performed; and any part or parts of the method 158 may be performed to provide a useful method 158.

At a block 160, the network diagnostic module 102 may access network activity data. The network activity data may be generated by the diagnostic module 102; one or more other suitable modules, systems, and the like; or any suitable combination of one or more thereof.

The diagnostic module 102 may use the network activity data to identify a first set of one or more components of the networking system 100 at the block 162 and to identify a second set of one or more components of the networking system 100 at the block 162. In one embodiment, the diagnostic module 102 may identify the members of the first and second sets based upon one or more similar network activity statistics. The diagnostic module 102 may identify the members of the first and second sets based upon their performance speed, their performance errors, and/or any other suitable network activity statistics. For example, the first set could comprise nodes communicating at a certain bandwidth, and the second set could comprise nodes communicating at a different bandwidth.

The diagnostic module 102 may access network configuration data for the first set of components at the block 166 and may access network configuration data for the second set of components at the block 168. At the block 170, the diagnostic module 102 may compare the network configuration data for the first set with the network configuration data for the second set to, for example, identify one or more network configuration characteristics shared among the first and second sets and/or identify one or more network configuration characteristics not shared among the first and second sets. Advantageously, this comparison may be used to identify one or more particular network configuration characteristics may affect the network activity of first and second sets of components. For example, this comparison could be used to determine that storage devices of one manufacturer are running slower than storage devices of other manufacturers. Also, for example, this comparison could be used to determine that switches running one version of a software product (such as a driver) experience more errors than switches running other versions of the software product. Of course, this comparison may be used to identify any other network configuration characteristics may affect the network activity of first and second sets of components.

### Exemplary Operating and Computing Environments

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module, such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, and firmware to implement those methods and systems described above. The functionality provided for in the software, hardware, or both may be combined into fewer components or further separated into additional components. Additionally, the components may advantageously be implemented to execute on one or more computing devices. As used herein, “computing device” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network diagnostic method comprising:
using network configuration data to automatically generate component-specific baseline network activity data from first network activity data.

2. The network diagnostic method as in claim 1, further comprising:
accessing second network activity data; and
comparing the component-specific baseline network activity data and the second network activity data.

3. The network diagnostic method as in claim 2, further comprising:
providing an alarm at least partially in response to comparing the component-specific baseline network activity data and the second network activity data.

4. The network diagnostic method as in claim 1, wherein the component-specific baseline network activity data comprises at least one boundary for a network activity statistic associated with a network component.

5. The network diagnostic method as in claim 1, wherein the component-specific baseline network activity data comprises at least one boundary for a network activity statistic associated with a network component and at least one time period.

6. A network diagnostic method comprising:
using network configuration data to identify a plurality of network components; and
aggregating network activity data for the plurality of network components.

7. The network diagnostic method as in claim 6, wherein the network activity data comprises a network activity statistic.

8. The network diagnostic method as in claim 6, wherein the aggregating network activity data for the plurality of network components comprises:
averaging a network activity statistic.

9. The network diagnostic method as in claim 6, wherein the aggregating network activity data for the plurality of network components comprises:
summing a network activity statistic.

10. The network diagnostic method as in claim 6, wherein the aggregating network activity data for the plurality of network components comprises:
calculating a standard deviation of a network activity statistic

11. A network diagnostic method comprising:
using network configuration data to identify a first set of one or more network components and a second set of one or more network components;
accessing first network activity data for the first set of one or more network components;
accessing second network activity data for the second set of one or more network components; and
comparing the first network activity data and the second network activity data.

12. The network diagnostic method as in claim 11, wherein the network configuration data indicates a manufacturer for the first set of one or more network components; and wherein the network configuration data indicates at least one other manufacturer of at least one of the second set of one or more network components.

13. The network diagnostic method as in claim 11, wherein the network configuration data indicates a software product run by the first set of one or more network components; and wherein the network configuration data indicates at least one other software product run by at least one of the second set of one or more network components.

14. The network diagnostic method as in claim 11, wherein the network configuration data indicates a version of a software product run by the first set of one or more network components; and wherein the network configuration data indicates at least one other version of a software product run by at least one of the second set of one or more network components.

15. The network diagnostic method as in claim 11, wherein the network configuration data indicates that the first set of one or more network components share a network configuration characteristic; and wherein the network configuration data indicates that the second set of one or more network components lack the network configuration characteristic.

16. A network diagnostic method comprising:
using network activity data to identify a first set of one or more network components and a second set of one or more network components;
accessing first network configuration data for the first set of one or more network components;
accessing second network configuration data for the second set of one or more network components; and
comparing the first network configuration data and the second network configuration data.

17. The network diagnostic method as in claim 16, wherein the first network configuration data indicates a manufacturer for the first set of one or more network components; and wherein the second network configuration data indicates at least one other manufacturer of at least one of the second set of one or more network components.

18. The network diagnostic method as in claim 16, wherein the first network configuration data indicates a software product run by the first set of one or more network components; and wherein the second network configuration data indicates at least one other software product run by at least one of the second set of one or more network components.

19. The network diagnostic method as in claim 16, wherein the first network configuration data indicates a version of a software product run by the first set of one or more network components; and wherein the second network configuration data indicates at least one other version of a software product run by at least one of the second set of one or more network components.

20. A network diagnostic method comprising:
automatically generating component-specific baseline network activity data from first network activity data.

21. The network diagnostic method as in claim 20, further comprising:
accessing second network activity data; and
comparing the component-specific baseline network activity data and the second network activity data.

22. The network diagnostic method as in claim 21, further comprising:
providing an alarm at least partially in response to comparing the component-specific baseline network activity data and the second network activity data.

23. The network diagnostic method as in claim 20, wherein the component-specific baseline network activity data comprises at least one boundary for a network activity statistic associated with a network component.

24. The network diagnostic method as in claim 20, wherein the component-specific baseline network activity data comprises at least one boundary for a network activity statistic associated with a network component and at least one time period.
